(19) United States
(12) Patent Application Publication
(10) Pub. No.: US 2010/0258470 A1
(43) Pub. Date: Oct. 14, 2010

(54) Container for tablets

(76) Inventor: Sébastien Lucien Fily, Gailard (FR)

Correspondence Address: BAYER HEALTHCARE LLC;CONSUMER CARE DIVISION, 36 COLUMBIA ROAD, MORRISTOWN, NJ, 07962, US

(21) Appl. No.: 12/799,742

(22) Filed: Apr. 30, 2010

(30) Foreign Application Priority Data
Oct. 30, 2007 (EP) 07021180.0
Oct. 21, 2008 (EP) PCT/EP2008/009185

(51) Int. Cl. B65D 83/04; B65D 85/00; B23P 19/04

(52) U.S. Cl. 206/530; 206/459.5; 29/700; 206/459.1

(57) ABSTRACT

A container for unit dosage forms having a tubular body with an opening at a first end and a base at a second end. The tubular body comprises a plurality of slits and has at least one area free of slits adapted for fixing a label to the tubular body that can substantially cover the plurality of slits.

### BACKGROUND OF THE INVENTION

1. Field of the Invention

The invention relates to a container for tablets, capsules and other unit dosage forms, especially pharmaceutical solid dosage forms and to a method of producing such a container.

2. Description of Related Art

Tablet containers are well known for holding prescription pharmaceuticals. They are generally tubular in shape with a closed bottom and an open top. The open top is adapted to mate with a top, often to form a child resistant system for holding, protecting, preserving and transporting solid unit dosage forms, especially prescription medications in solid dosage form. Tablet containers are also known as tablet vessels or rigid tubes for tablets.

European Patent No. 1,179,475 (corresponding to U.S. Pat. No. 6,581,355 to Yuyama et al., issued Jun. 24, 2003) shows a tablet vessel with a tubular body. The body has an opening on one side and a base that completes the tubular body on the other side. Tablets are fed into the tablet vessel through the opening on the tablet vessel. The tablet filling device also has a label fitting portion for fitting a label on the outer surface of the tablet vessel as the tablet vessel is guided through the tablet filling device. This tablet vessel, however, contains too much mass. The art still needs an improved container for tablets.

### SUMMARY OF THE INVENTION

The principal object of the invention therefore is to provide a container for tablets. The container comprises a tubular body with an opening at a first end and a base at a second end of the tubular body. The second end is on the opposite side of the tubular body with regard to the first end and so the base completes the tubular body. The tubular body further comprises a plurality of slits and at least one area on the outer surface of the tubular body that is free of slits. This area is designed for affixing a label to the tubular body.

One advantage of the invention is that it provides a tablet vessel with an improved design over that set forth in European Patent No. 1,179,475. The container of the invention comprises a plurality of slits in its tubular body. These slits do not contain any material and thus do not contribute to the mass of the container. A container in accordance with the invention having a comparable size to a container made according to EP 1,179,475 will be lighter, especially if the total volume of the slits corresponds to a relatively large fraction of the total volume of the tubular body.

Another advantage of the invention is that the containers have advantages when used in industrial operations. When filled with tablets, pharmaceutical containers are usually distributed to warehouses, distributors, wholesalers, or pharmacies, by truck. A truck load of such material usually comprises many containers, so that a reduction in mass due to the slits in each container offers considerable advantages over other designs. Less fuel per truck load is required which reduces transport costs and pollution. Since less material is needed for the production of a container, the container is less expensive than other designs.

Additional objects and advantages of the invention will be set forth in part in the description that follows, and in part will be obvious from this description, or may be learned by practice of the invention. The objects and advantages of the invention may be realized and attained by means of the instrumentalities and combinations particularly pointed out in the appended claims.

### BRIEF DESCRIPTION OF THE FIGURES

In the following embodiments of the invention are described in detail making reference to the drawings in which:

FIG. 1 shows side views of a container,

FIG. 2 shows a top view of the container,

FIG. 3 shows a bottom view of the container,

FIG. 4 shows a side view on a portion of the container,

FIG. 5 shows a perspective view of the second end of the tubular body with the base that completes the tubular body at this end,

FIG. 6 shows a perspective view of a portion of the container, especially the labeling area, and

FIG. 7 shows a flow diagram illustrating steps performed by a method in accordance with the invention.

### DESCRIPTION OF THE PREFERRED EMBODIMENTS

The invention comprises a container that is useful for transporting unit dosage forms, such as tablets, pills and capsules. Preferably the container comprises a tubular body sealed at one end that is adapted to receive a plurality of the unit dosage forms. These items may be placed in the container in random fashion, in which case the container is preferably substantially larger in diameter than each individual dosage form. In a preferred embodiment of the invention, however, the unit dosage forms have a substantially uniform thickness and cross section and are designed to be stacked on top of each other in a regular pattern. In this embodiment of the invention, the diameter of the container may more closely approximate the diameter of the dosage form.

The container of the invention preferably comprises a plurality of slits disposed around the circumference of the tubular body. The slits should not be so large as to permit the unit dosage form in the container to escape. The container may also comprise a lid or cap that can be removed to allow access to the unit dosage forms inside the container. In a preferred embodiment, this lid or cap is adapted to be replaced after one or more of the unit dosage forms has been removed so that unit dosage forms remaining in the container may be retained. In another preferred embodiment, the lid or cap is resistant to opening by children.

In one preferred embodiment of the invention, the container comprises a label affixed to the container. The label is attached to the container, preferably by an adhesive material, at a specific region of the container adapted to receive or engage at least an adhesive portion of the label. Preferably, the label wraps around the tubular body of the container so that it completely covers the slits.

The label can, for example, be attached to the area designed to engage the label by use of a glue or adhesive that is placed between the area of the label to be engaged and the area on the tubular body adapted to engage the label. The rest of the label may then be wrapped around the tubular body, thereby covering the slits, and the ends of the label may overlap to allow the label to self adhere at the point of overlap. In another embodiment of the invention, the label may wrap around the tubular body to surround the tubular body by more than the circumference of the tubular body.

Containers in accordance with the invention may be mass-produced. Unit dosage forms, particularly pharmaceuticals, over-the-counter medicines and vitamins and nutritional and dietary supplements may also be mass-produced. The dimensions of the containers and unit dosage forms are subject to tolerances. One advantage of the invention is that an overlapping label is not required to meet a strict tolerance level, which allows for easier processing of the filled containers. Fewer containers will also be rejected because of misaligned or mismatched labels, and overlapped labels also have a pleasing appearance.

The surface of the label that faces the outer surface of the tubular body may, for example, be covered with an adhesive material, such as a glue, so that the inner surface of the label that faces the outer surface of the tubular body sticks to the tubular body and seals the inside of the container from the outside when the opening of the container is closed by a cap. Depending on the material that is used to manufacture the label, unit dosage forms in the container can be isolated from light, moisture, oxygen, and other gases and fluids that can have a deleterious effect on the unit dosage forms.

In another embodiment, the label may comprise of a plurality of layers, wherein at least one of the layers is a metallic layer. Preferably, the metallic layer comprises aluminum layer. An aluminum layer can be relatively thin and flexible without forming holes in the layer. The layer will assist the label in providing high flexibility and good isolation properties. Permeation of moisture can often be reduced by up to about 65% by use of a multi-layer label having at least one layer of aluminum rather than using direct printing on a tube body or using a single layer or multi-layer label that only comprises paper-based layers.

In accordance with an embodiment of the invention, the tubular body comprises a slit-free section at the first end and a slit-free section at the second end, wherein the slit-free sections at the first and second ends are free of slits. These slit-free sections are preferably adapted to receive adhesive portions of a label. The slit-free sections at both ends of the tubular body also allow for relatively high tolerances in the dimensions of the labels that are wrapped around the containers.

Relatively small sized labels can thus fully cover all the slits. A first end of a label can be attached, e.g. glued, to a slit-free section on the side of the tubular body, and the upper and lower edges of the label may be attached to the slit-free sections at the top and bottom of the tubular body. The second end of the label, which has not been glued to the tubular body, can be glued to the first end of the label once the label has been wrapped entirely around the tubular body. The label thus covers and seals all the slits in the tubular body from the exterior.

In another embodiment of the invention, the tubular body or the base of the container may comprise an indicator, located in a predefined position with respect to the area on the tubular body where the label is to be attached. The indicator provides an indication for an automated machine that wraps the label around the tubular body and allows for the positioning of the tubular body so that an edge of the label can be glued to the area of the tubular body in a proper orientation. This indictor is particularly helpful in preventing incomplete coverage of the slits or misalignment of the label, which could adversely affect the adhesion between the label and the tubular body.

In another embodiment of the invention, the container further comprises a plurality of pins disposed at the bottom of the tubular body and directed upward. The pins of the plurality of pins are arranged on the inner surface of the base and the pins of the plurality of pins are distributed over the inner surface of the base. Each pin of the plurality of pins has a longitudinal axis which is oriented in essence parallel to the longitudinal access of the tubular body. The pins are adapted to provide resilience for tablets filled into the container. Thus, the pins are preferably elastic and can absorb shocks that might occur, for example, during transport of the filled container and that could damage the unit dosage forms.

The tubular body of the container is preferably rigid. In particular, the size, shape, and amount of the slits are adapted such that the integrity of the tubular body is not compromised and unit dosage forms may be safely stored in the container. The base should also comprise a rigid structure. The tubular body and the base may be made of any suitable material known in the art, but preferred materials include polypropylene (PP), low-density polyethylene (LDPE), high-density polyethylene (HDPE), or cyclo-olefin copolymer (COC).

The invention also comprises a method of producing the container. A tubular body is produced with an opening at a first end and a closed base, wherein the base completes the tubular body at a second end of the tubular body. The second end is located on the opposite side of the tubular body with respect to the first end. The tubular body is produced so that it comprises a plurality of slits and at least one label area that relates to a contiguous portion of the outer surface of the tubular body which is free of slits. The label area is intended to allow for the fixation of a label to the tubular body. An edge region of a label is then affixed to the label area of the tubular body. Then, the label is wrapped around the tubular body so that the label covers the slits in the tubular body at least once.

The invention also comprises an apparatus for performing the method of the invention.

The invention will be better understood by reference to the preferred embodiment set forth in the accompanying drawings.

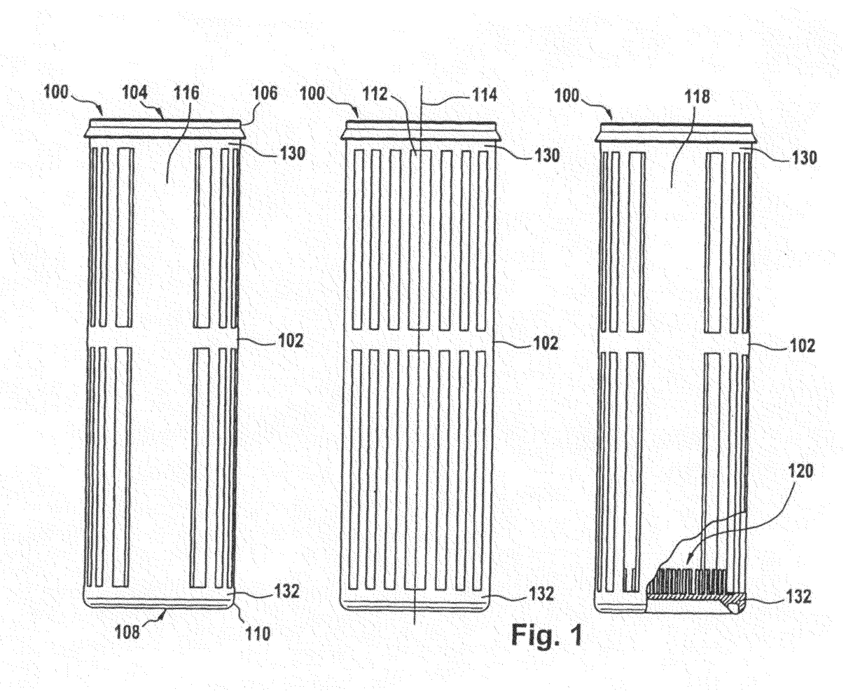

FIG. 1 shows various side views of a container 100. The image in the center of FIG. 1 shows a front view of the container 100, the left side of FIG. 1 shows a side view of the container 100, and the right side of FIG. 1 shows the opposite side view of the container 100.

The container 100 comprises a tubular body 102 with an opening 104 at a first end 106 of the tubular body. The container 100 further comprises a base 108 that completes the tubular body 102 at a second end 110 of the tubular body.

The container 100 further comprises a plurality of slits such as, for example, slit 112. The slits relate to openings in the tubular body. The slits are designed and located in the tubular body so that the rigidity of the tubular body is comparable to the rigidity of a tubular body without slits 112. Thus the container can be used as a safe repository for tablets and pills.

Each slit of the plurality of slits preferably has a rectangular shaped cross section with a longitudinal axis that runs substantially parallel to the longitudinal axis 114 of the container. In a preferred embodiment of the invention, the slits are arranged in two rows around the circumference of the tubular body 102 and aligned so that two slits are arranged sequentially to each other along the longitudinal axis 114 of the container.

The tubular body 102 further comprises a first label area 116 and a second label area 118 that are contiguous portions of the outer surface and that are free of slits. The first and second label areas 116, 118 are designed for fixing a label (not shown in FIG. 1) to the tubular body 102. Preferably, the label areas 116 and 118 are designed to provide a contiguous surface on which a label, such as a paper label, can be attached to the tubular body, preferably by use of an adhesive material.

The tubular body 102 also preferably comprises a first slit-free section 130 and a second slit-free section 132. The first slit-free section 130 is located at the first end 106 while the second slit-free section 132 is located at the second end 110. The slit-free sections separate the slits from the ends 106, 110 of the tubular body 102. A label can be wrapped around the outer surface of the tubular body 102 between the first end 106 and the second end 110, attached to tubular body 102 by adhesion to the two slit-free sections 130, 132 and, optionally to one or more of the label areas 116 118. In such an embodiment, the label can completely cover all slits in the tubular body 102.

The base 108 of the container 100 may also comprise a plurality of pins 120. The plurality of pins 120 is shown in a cut away view of the container 100 on the bottom right side of FIG. 1. The pins are arranged with each longitudinal axis oriented substantially parallel to the longitudinal axis of the tubular body 114 and directed towards the inside of the container 100. The pins are preferably elastic and flexible to provide resilient support and cushioning for unit dosage forms that are filled into the container during use.

The first end 106 is adapted to engage a cap (not shown) that can close the opening 104 of the container to retain the unit dosage forms filled in the container during use.

The mass of the container shown in FIG. 1 is about 38% lower than the mass of a container made of the same material and with identical dimensions but without slits. This reduction in weight can provide significant advantages in manufacturing and transportation of unit dosage forms. A preferred embodiment of the container shown in FIG. 1 has a height along the longitudinal axis 114 of from about 30 to about 200 mm. The preferred height will be affected by the number and type of unit dosage forms to be placed in the container. The diameter of the tubular bodies of this preferred embodiment may be from about 20 to about 60 mm. The height of the first and second slit-free sections 130, 132 may be from about 3 to about 12 mm. The height of the slits along the longitudinal axis in the preferred embodiment may be from about 4 to about 20 mm. Preferably from about 10 to about 15 slits are arranged in each row around the circumference of the tubular body 102, and the area of each slit preferably matches the area of the tubular body disposed between two neighboring slits.

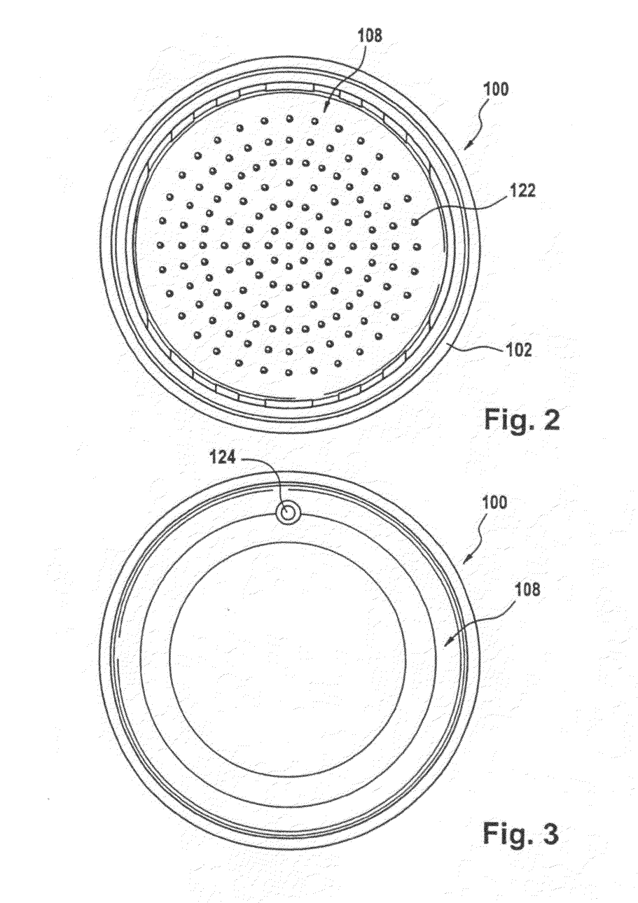

FIG. 2 shows a top view on the container looking into tubular body 102 so that the inner surface of the base 108 is visible and shows the plurality of pins, for example pin 122, disposed therein. The pins are preferably arranged in a regular pattern on the inner surface of the base 108 and provide good resilience for unit dosage forms with a circular cross section having a diameter corresponding approximately to the diameter of the base 108. The diameter of the base 108 preferably accommodates unit dosage forms, such as tablets, in a stacked arrangement so that the unit dosage forms may remain in the container without unacceptable levels of radial backlash. The height of the tubular body in a preferred embodiment may also be set so that a predetermined number of unit dosage forms, for example 5, 10, 15, or 20 tablets, can be stacked in the container.

The tubular body of a container is not restricted to a circular cross section. Another Elliptical, rectangular, square or even an irregular cross section may be employed to be complementary to the unit dosage form to be stacked in the container.

FIG. 3 shows a bottom view of a preferred embodiment of the container 100, showing the outer surface of the base 108. The base 108 may comprise an indicator 124 that can comprise a recess located in a predefined position with respect to the first area 116 and the second area 118 of the container 100. The indicator 124 provides an indication or defined point for an automated apparatus that wraps a label around the container 100. The indicator 124 can be easily detected by the apparatus and can be used to used to align the container 100 so that a properly oriented label can be affixed to the container.

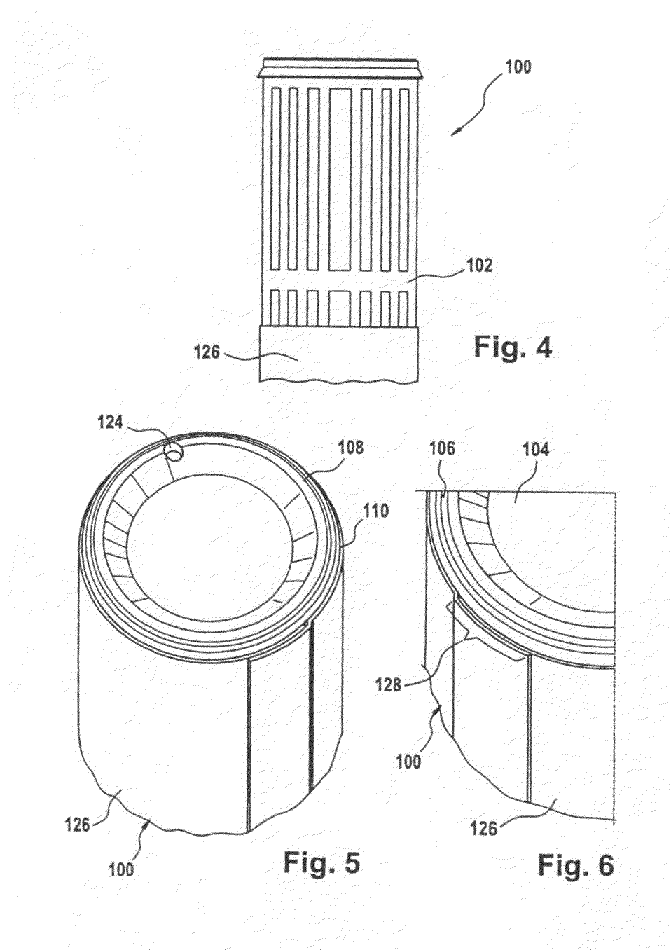

FIG. 4 shows a side view of a portion of the container 100. A label 126 is shown wrapped around the tubular body 102. Preferably, the label would be wrapped around the tubular body 102 to covers all the slits substantially completely. For ease of reference, FIG. 4 shows a label 126 that only partially covers one row of slits.

FIG. 5 shows a perspective view of the second end 110 of the tubular body 102. It shows the base 108 with the indicator 124 that completes the end 110 of the container 100. The label 126 is wrapped around the tubular body so that it substantially covers the circumference of the tubular body. In alternative embodiments of the invention, the label may cover less than the entire circumference of the container 100 or may be wrapped multiple times around all or part of the circumference.

FIG. 6 shows a perspective view of a portion of the container 100. The label 126 is wrapped around the tubular body so that one portion of the label 126 covers another portion of the label in overlapping region 128. This arrangement is particularly preferred because it provides an effective cover of the container is obtained and allows a relatively high tolerance for the dimensions of the label in manufacturing operations.

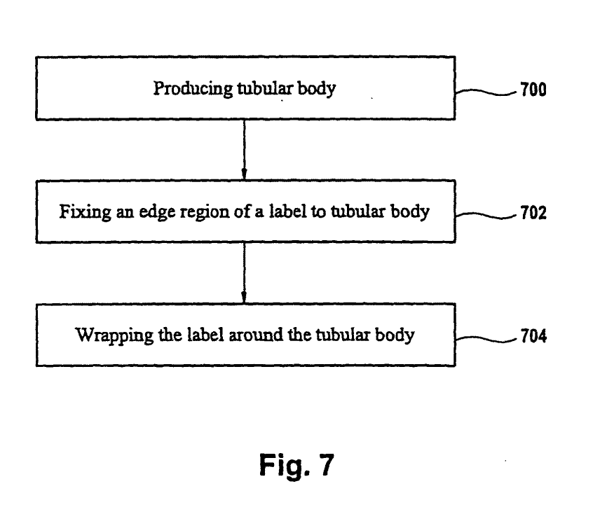

FIG. 7 shows a flow diagram illustrating steps performed in a method for producing a container for tablets in accordance with the invention.

A tubular body with an opening at a first end and a base is produced in step 700. The base completes the tubular body at a second end of the tubular body, wherein the second end is located on the opposite side of the tubular body with respect to the first end. The tubular body is produced so that it comprises a plurality of slits and at least one area. The at least one area relates to a contiguous portion of the outer surface of the tubular body which is free of slits. The at least one area is furthermore designed to fix, in particular to glue, a label to the tubular body. An edge region of a label is fixed to the area of the tubular body in step 702 and the label is wrapped around the tubular body in step 704, preferably so that the label covers the circumference of the tubular body at least once.

What is claimed is:

1. A container for unit dosage forms comprising:
a. a tubular body;
b. an opening at a first end of said tubular body;
c. a base disposed at a second end of said tubular body, wherein the second end is opposite said first end and wherein said base completes said tubular body;
d. a plurality of slits disposed in said tubular body; and
e. at least one label area comprising a contiguous portion of the outer surface of said tubular body that is free of slits, wherein said label area is adapted for adhering at least one portion of label affixed to said label area.

2. The container of claim 1, further comprising a label attached to said label area and wrapped around a substantial portion of said tubular body.

3. The container of claim 2, wherein said label substantially covers said plurality of slits.

4. The container of claim 3, wherein said label is disposed around the outer surface of said tubular body so that said label surrounds the circumference of said tubular body at least once.

5. The container of claim 4, wherein said label substantially seals said plurality of slits.

6. The container of claim 1, wherein said tubular body further comprises a first slit-free section disposed at the first end of said tubular body and a second slit-free section disposed at the second end of said tubular body.

7. The container of claim 1, wherein said first end of said tubular body is adapted to receive a lid that substantially covers said opening.

8. The container of claim 1, further comprising further comprising an indicator located in a predefined position with respect to said at least one label area.

9. The container of claim 1, further comprising a plurality of pins disposed on the inner surface of said base, wherein the longitudinal axis each pin is oriented substantially parallel to the longitudinal axis of said tubular body.

10. The container of claim 9, wherein said pins are adapted to provide resilient support for said unit dosage forms.

11. A method for producing a container for unit dosage forms, comprising the steps of:
a. producing a tubular body with an opening at a first end and a base at a second end opposite said first end, wherein said base completes said tubular body, and wherein said tubular body further comprises a plurality of slits and at least one label area, wherein the at least one label area relates to a contiguous portion of the outer surface of the tubular body which is free of slits, wherein said at least one label area is designed for fixing a label to said tubular body;
b. fixing an edge region of a label to said label area; and
c. wrapping said label around said tubular body so that said label covers said circumference of said tubular body at least once.

12. The method of claim 11, wherein said tubular body comprises an indicator located in a predefined position with respect to the at least one label region, and wherein said step of fixing said edge region of said label to said label area comprises the steps of:
a. detecting the indicator;
b. aligning the tubular body by use of said indicator so that the label area is in a position to receive said edge region of said label is attachable; and
c. affixing said edge region of said label to said label area.

13. The method of claim 12, wherein said step of producing said tubular body comprises injection molding of a thermoplastic or thermosetting plastic material.
